(19) United States
(12) Patent Application Publication
(10) Pub. No.: US 2018/0313302 A1
(43) Pub. Date: Nov. 1, 2018

(54) COOLANT TEMPERATURE MODULATION FOR EXHAUST GAS RECIRCULATION SYSTEM

(71) Applicant: Progress Rail Locomotive Inc., LaGrange, IL (US)

(72) Inventors: Jaldeep Niranjan Kansara, Bolingbrook, IL (US); Arvindkumar Makasana, Naperville, IL (US); Juan Carlos Marroquin, Lisle, IL (US)

(73) Assignee: Progress Rail Locomotive Inc., LaGrange, IL (US)

(21) Appl. No.: 15/581,040

(22) Filed: Apr. 28, 2017

(51) Int. Cl. F02M 26/33; F02D 41/08; F02D 41/00; F02B 61/00; F04D 27/00

(52) U.S. Cl. CPC F02M 26/33; F02D 41/086; F02M 26/05; F02B 61/00; F04D 27/004; F02D 41/005

(57) ABSTRACT

A control system for an exhaust gas recirculation system for an engine is provided. The control system includes an exhaust gas recirculation (EGR) cooler having a coolant flowing therethrough. The control system includes an externally controlled coolant set-point circuit associated with the EGR cooler. The control system also includes a controller communicably coupled to the externally controlled coolant set-point circuit. The controller is configured to receive a first signal indicative of a readiness of the engine to load. The controller is configured to receive a second signal indicative of a temperature of the coolant. The controller is configured to receive a third signal indicative of a first temperature zone associated with the engine. Further, the controller is configured to modulate a set-point temperature of the coolant over a range of temperatures based on the received signals and a temperature gradient of the coolant.

### TECHNICAL FIELD

The present disclosure relates to an exhaust gas recirculation system of a locomotive and more particularly to a coolant circuit associated with the exhaust gas recirculation cooler of the system.

### BACKGROUND

An engine system of a locomotive generally includes an Exhaust Gas Recirculation (EGR) system associated therewith. The EGR system reduces NOx generation and increases efficiency of the engine system by recirculating a part of the exhaust gases to an air intake system of an engine. An EGR cooler is associated with the EGR system for cooling the recirculated exhaust gases.

However, during extended idle conditions of the engine, there is a possibility of soot build-up in the EGR cooler due to condensation in a cooling pipe of the EGR cooler. This build-up of soot may result in loss of heat transfer capability, affecting an efficiency of the EGR cooler. Further, the build-up may cause fouling of the EGR cooler, reducing an overall effectiveness of the EGR system, resulting in increased emissions and decreased fuel efficiency.

U.S. Pat. No. 9,212,630 describes various methods and systems for regeneration of an exhaust gas recirculation cooler. The method includes adjusting cooling of exhaust gas by an exhaust gas recirculation cooler to maintain a manifold air temperature during an idle condition of an engine. The method further includes initiating regeneration of the exhaust gas recirculation cooler during the idle condition when an effectivity of the exhaust gas recirculation cooler falls below a threshold effectivity prior to or during the idle condition.

### SUMMARY OF THE DISCLOSURE

In one aspect of the present disclosure, a control system for an exhaust gas recirculation system for an engine is provided. The control system includes an exhaust gas recirculation (EGR) cooler having a coolant flowing therethrough. The control system includes an externally controlled coolant set-point circuit associated with the EGR cooler. The control system also includes a controller communicably coupled to the externally controlled coolant set-point circuit. The controller is configured to receive a first signal indicative of a readiness of the engine to load. The controller is configured to receive a second signal indicative of a temperature of the coolant. The controller is configured to receive a third signal indicative of a first temperature zone associated with the engine. Further, the controller is configured to modulate a set-point temperature of the coolant over a range of temperatures based on the received signals and a temperature gradient of the coolant.

In another aspect of the present disclosure, a method for controlling an exhaust gas recirculation system for an engine is provided. The method includes receiving, by a controller, a first signal indicative of a readiness of the engine to load. The method includes receiving by the controller, a second signal indicative of a temperature of a coolant associated with an exhaust gas recirculation (EGR) cooler. The method includes receiving, by the controller, a third signal indicative of a first temperature zone associated with the engine. The method includes modulating, by the controller, a set-point temperature of the coolant over a range of temperatures based on the received signals and a temperature gradient of the coolant.

In another aspect of the present disclosure, an engine system for a locomotive is provided. The engine system includes an exhaust gas recirculation system and an exhaust gas recirculation (EGR) cooler having a coolant flowing therethrough. The engine system includes an externally controlled coolant set-point circuit associated with the EGR cooler. The externally controlled coolant set-point circuit includes a radiator and a cooling fan associated therewith. The engine system includes a controller communicably coupled to the externally controlled coolant set-point circuit. The controller is configured to receive a first signal indicative of a readiness of the engine to load. The controller is configured to receive a second signal indicative of a temperature of the coolant. The controller is configured to receive a third signal indicative of a first temperature zone associated with the engine. The controller is configured to modulate a set-point temperature of the coolant over a range of temperatures based on the received signals and a temperature gradient of the coolant. The controller is configured to control a fan speed of the cooling fan based on the modulation.

Other features and aspects of this disclosure will be apparent from the following description and the accompanying drawings.

### BRIEF DESCRIPTION OF THE DRAWINGS

FIG. 1 is a schematic view of an exemplary engine system having an Exhaust Gas Recirculation (EGR) system, according to various concepts of the present disclosure;

FIG. 2 is a block diagram of a control system associated with the EGR system, according to various concepts of the present disclosure; and

FIG. 3 is a flowchart of a method for controlling the EGR system, according to various concepts of the present disclosure.

### DETAILED DESCRIPTION

Wherever possible, the same reference numbers will be used throughout the drawings to refer to the same or the like parts. Also, corresponding or similar reference numbers will be used throughout the drawings to refer to the same or corresponding parts.

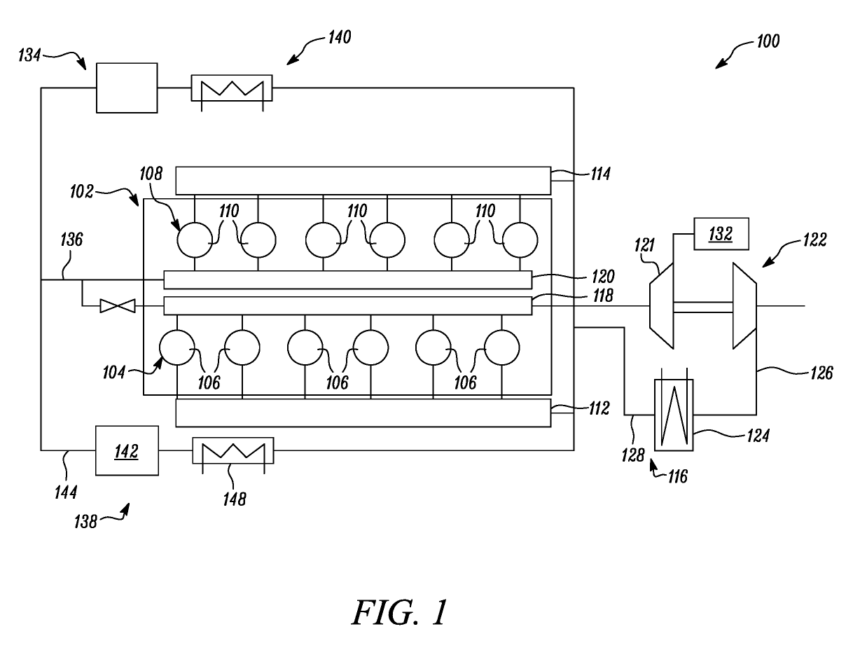

FIG. 1 illustrates an exemplary engine system 100 for a locomotive, according to one embodiment of the present disclosure. The engine system 100 of the locomotive includes an engine 102. In one embodiment, the engine 102 may include, for example, a diesel engine, a gasoline engine, a gaseous fuel powered engine such as, a natural gas engine, or any other type of internal combustion engine apparent to one of skill in the art.

The engine 102 includes a first group of cylinders 104 having individual cylinders 106. Further, the engine 102 also includes a second group of cylinders 108 having individual cylinders 110. The engine 102 further includes intake manifolds 112, 114 associated with each of the first and second group of cylinders 104, 108. The intake manifolds 112, 114 receive intake air, which may include recirculated exhaust gases therein, through an air intake system 116. The engine 102 also includes exhaust manifolds 118, 120 associated with each of the first and second group of cylinders 104, 108. Products of combustion may be exhausted from the first and second group of cylinders 104, 108 via the exhaust manifold 118, 120 respectively.

Ambient air may be drawn into the engine 102 through an air filter (not shown) of the air intake system 116. The air intake system 116 of the engine system 100 includes a turbocharger 122. The intake air is introduced in the turbocharger 122 for compression purposes, leading to a higher pressure thereof. The compressed intake air may then flow towards an aftercooler 124, via a line 126. The aftercooler 124 is configured to decrease a temperature of the intake air flowing therethrough. In one example, the aftercooler 124 may be embodied as an air to air aftercooler. Alternatively, the aftercooler 124 may embody an air to liquid aftercooler.

The engine system 100 also includes an exhaust system 132. In the illustrated embodiment, the exhaust system 132 is provided in fluid communication with the exhaust manifold 118. Alternatively, the exhaust system 132 may be provided in fluid communication with the exhaust manifold 120, or with both the exhaust manifolds 118, 120. Further, in order to reduce the formation of NOx, an exhaust gas recirculation (EGR) process may be used to keep the combustion temperature below a NOx threshold. Therefore, a portion of the exhaust gas flow exiting the engine 102 is recirculated to the intake manifolds 112, 114 of the engine 102. An EGR system 134 is associated with the engine system 100. The EGR system 134 recirculates a portion of the exhaust gas flow to each of the intake manifolds 112, 114.

In the illustrated example, the EGR system 134 is in fluid communication with the exhaust manifold 120 of the second group of cylinders 108, via an exhaust gas line 136. More particularly, the exhaust manifold 120 of the second group of cylinders 108 is fluidly coupled to the engine 102 such that the portion of the exhaust gases generated by the second group of cylinders 108 are recirculated to the engine 102. In one example, the second group of cylinders 108 may be referred to as donor group of cylinders. Whereas, the first group of cylinders 104 are referred to as non-donor group of cylinders. In the present example, the exhaust gases exiting the first group of cylinders 104 drive a turbine 121 of the turbocharger 122. In alternate examples, the first group of cylinders 104 may be embodied as the donor group of cylinders, or both the first and second group of cylinders 104, 108 may be embodied as the donor group of cylinders.

The exhaust gases flowing through the exhaust gas line 136 split to flow through a first EGR system 138 and a second EGR system 140. The first EGR system 138 recirculates the exhaust gases to the intake manifold 112, whereas the second EGR system 140 recirculates the exhaust gases to the intake manifold 114. For simplicity purposes, the first EGR system 138 will now be explained in detail with reference to the accompanying figures. However, it should be noted that the description provided below is equally applicable to the second EGR system 140, without limiting the scope of the present disclosure.

The first EGR system 138 includes an exhaust gas treatment module 142. The exhaust gas treatment module 142 is provided on a main line 144. The first EGR system 138 also includes an EGR cooler 148. The exhaust gas treatment module 142 is disposed upstream of the EGR cooler 148, with respect the exhaust gases flowing through the main line 144. The EGR cooler 148 cools the high temperature exhaust gases leaving the engine 102, by heat exchange with a coolant. More particularly, due to heat exchange between the exhaust gases and the coolant, the temperature of the exhaust gases may be regulated by the EGR cooler 148. A person of ordinary skill in the art will appreciate that the EGR cooler 148 may include any air/coolant heat exchanger known to a person of ordinary skill in the art.

In the described locomotive, the coolant flows through an externally controlled coolant set-point circuit (not shown). The externally controlled coolant set-point circuit includes a pump (not shown). The system may also include a number of radiators (not shown) such that an outlet of each of the radiators is connected to the pump. An inlet of each of the radiators is connected to an outlet of the EGR cooler 148. The arrangement of the radiators and the number of the radiators in the system may vary based on the system requirements.

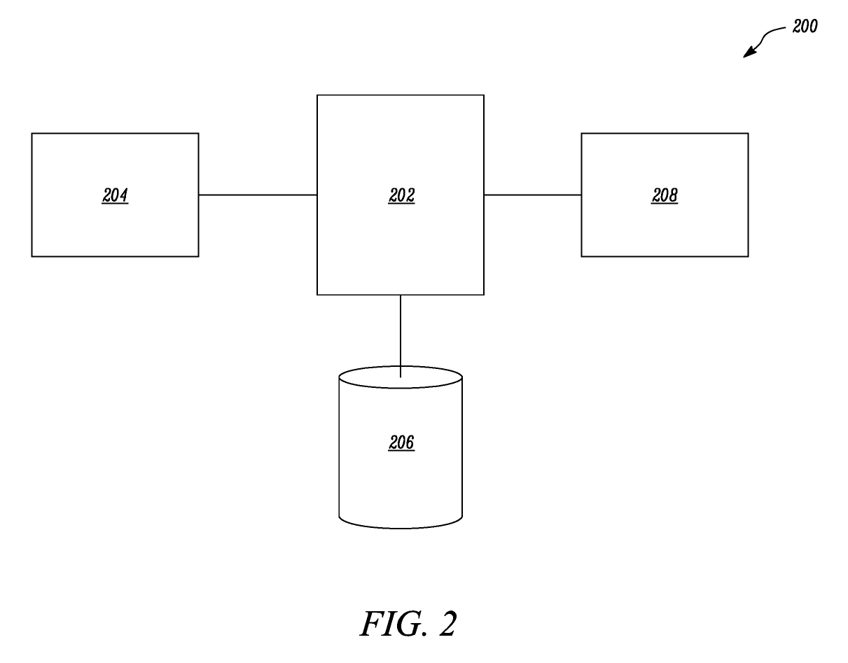

A cooling fan 208 (see FIG. 2) is associated with each of the radiators to regulate a temperature of the coolant flowing through the radiator. More particularly, a fan speed of each of the cooling fans 208 may be regulated to control a temperature of the coolant flowing through the system. During operation, the coolant flows from the outlet of the radiators into the engine 102 via the pump. The coolant exits the engine 102 and enters into the EGR cooler 148. The coolant further flows towards the engine 102 and further into the inlet of each of the radiators. The described externally controlled coolant set-point circuit is an exemplary circuit in which the temperature of the coolant is regulated by the cooling fan 208. Other externally controlled cooling circuits may also be utilized, without deviating from the scope of the present disclosure. The engine system 100 and components described herein are exemplary and do not limit the scope of the present disclosure. The engine system 100 may additionally include other components or assemblies not included in this description.

The present disclosure relates to a control system 200 associated with the first and second EGR systems 138, 140 respectively for controlling a set-point temperature of the coolant. Referring to FIG. 2, the control system 200 includes a controller 202. The controller 202 is configured to modulate the set-point temperature of the coolant flowing through the EGR cooler 148 based on a variety of parameters, for example, a temperature of the coolant, a readiness of the engine to load, an ability of the engine to load, a current state of the engine, a temperature gradient of the coolant and/or ambient temperature conditions. The working of the controller 202 will now be described in detail.

The controller 202 is configured to receive a number of signals in order to modulate the set-point temperature of the coolant. The controller 202 receives a first signal indicative of the readiness of the engine 102 to load. This signal may be indicative of a correlated low-point temperature of the set-point temperature range so that the low-point of the coolant is modulated by the controller 202 such that the system is ready to load anytime a user changes a throttle setting of the system. Further, the controller 202 receives a second signal indicative of the current temperature of the coolant. The controller 202 also receive a third signal indicative of a first temperature zone of the engine 102. The first temperature zone may be indicative of the ability of the engine 102 to load. The first temperature zone is a predefined hot zone of the engine 102. For example, the first temperature zone may be defined as approximately 65° C. and above. This temperature may vary based on the engine 102.

Optionally or additionally, the controller 202 may also receive a fourth signal indicative of the ambient temperature. Further, the controller 202 may also receive a fifth signal indicative of the temperature gradient of the coolant. The controller 202 may receive some or all of these signals from an electronic control module (ECM) 204 associated with the engine 102. In other embodiments, the controller 202 may receive some or all of these signals from a control unit (not shown) associated with the locomotive. These signals may either be received directly from the ECM 204 and/or the control unit, and/or some or all of these signals may be computed or calculated based on other signals generated and monitored by the system.

Further, the controller 202 may be connected to a database 206. The database 206 may include any online or offline data source or data repository for storing information related to the correlation of the parameters associated with the received signals and the corresponding range of temperatures of the set-point temperature of the coolant. These parameters may include, the readiness of the engine 102 to load, the temperature of the coolant, the first temperature zone of the engine 102, the ambient temperature and/or the temperature gradient of the coolant. The database 206 may accordingly contain prehistoric or calculated set-point temperature ranges so that the controller 202 may retrieve this stored information for appropriately modulating the set-point temperature of the coolant. This data may be in the form of look-up tables, maps, or any other suitable dataset for correlating the received parameters and the set-point temperature range. Alternatively, the set-point temperature range may be computed by the controller 202 based on a mathematical formula, equation, or suitable data model considering the parameters given above.

It should be noted that when the engine 102 is on, the set-point temperature of the coolant may generally lie in the hot zone of the engine 102. During operation of the engine 102, if the temperature of the coolant exceeds the set-point temperature, the cooling fan 208 associated with the radiator is used to cool down the coolant. At this time, the recirculation of the exhaust gases may take place in the system as needed.

When the engine 102 is in the idle state for extended periods of time, the control system 200 is configured to modulate the set-point temperature of the coolant based on the signals received by the controller 202. More particularly, the controller 202 modulates the set-point temperature of the coolant to lie within a range of temperatures. The low-point of the range may be determined based on the readiness of the locomotive to load, while the high-point of the range may be determined based on the hot zone of the engine 102. For example, the range may lie approximately between 50 and 65° C.

Further, the controller 202 may be connected to the cooling fan 208. The controller 202 may regulate the fan speed of the cooling fan 208 for modulating the set-point temperature of the coolant. In other embodiments, the controller 202 may be connected to any other component of the externally controlled coolant set-point circuit for modulating the set-point temperature of the coolant.

Using some, all, or any suitable combination of these received signals, the controller 202 may modulate or lower the set-point temperature of the coolant over the range of temperatures such that the coolant temperature may remain in a predefined cold zone of the engine 102 during an idle state or extended idle conditions of the engine. For example, temperatures below 65° C. may lie in the cold zone of the engine 102. By doing so, the controller 202 may ensure that for majority of the time, the coolant temperature is maintained within the cold zone of the engine 102 during the idle state of the engine 102, while remaining in the hot zone for minimal time. Further, the controller 202 may restrict the recirculation of exhaust gases by the first and second EGR systems 138, 140, causing lesser or no recirculation in the system during the idle state of the engine 102 based on the modulation in the set-point temperature of the coolant.

The controller 202 may be a microprocessor or other processor as known in the art. The controller 202 may embody a single microprocessor or multiple microprocessors for receiving signals from components of the engine system 100. Numerous commercially available microprocessors may be configured to perform the functions of the controller 202. A person of ordinary skill in the art will appreciate that the controller 202 may additionally include other components and may also perform other functions not described herein.

### INDUSTRIAL APPLICABILITY

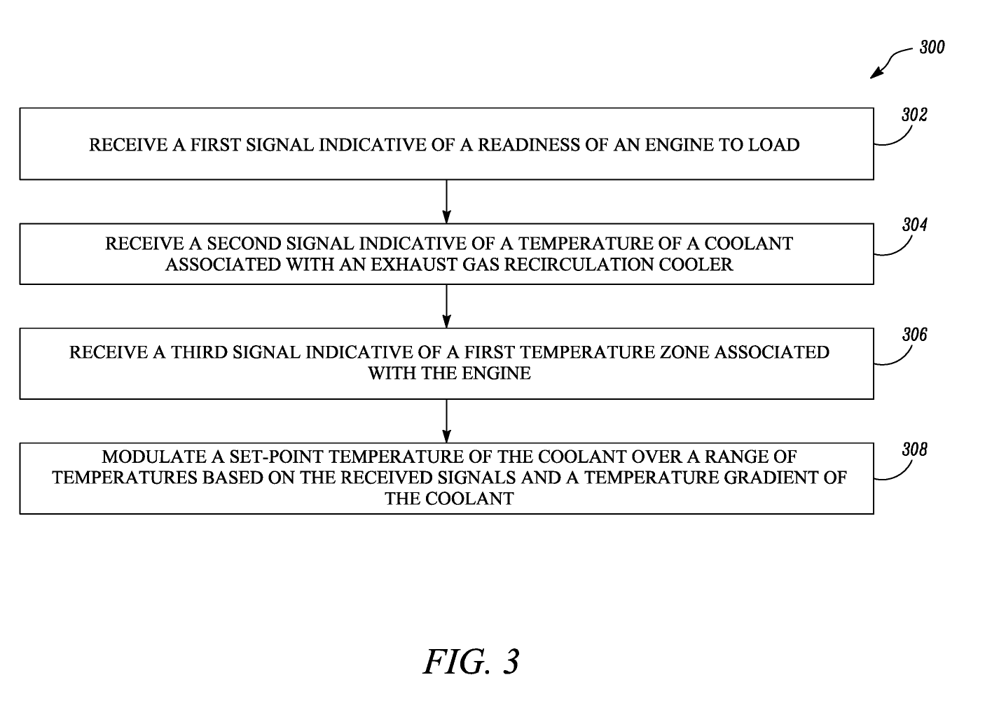

The present disclosure relates to a system and a method 300 for controlling a set-point temperature of the coolant during extended idle conditions of the engine 102. Referring to FIG. 3, at step 302, the controller 202 receives the first signal indicative of the readiness of the engine 102 to load. At step 304, the controller 202 receives the second signal indicative of the temperature of the coolant associated with the EGR cooler 148. At step 306, the controller 202 receives the third signal indicative of the first temperature zone associated with the engine 102. Further, at step 308, the controller 202 modulates the set-point temperature of the coolant over the range of temperatures based on the received signals and the temperature gradient of the coolant.

The controller 202 modulates the set-point temperature of the coolant during the idle state of the engine 102. Further, since the set-point temperature of the coolant is lowered such that the set-point temperature of the coolant lies in the cold zone of the engine 102 during the idle state, the modulation may cause partial or no recirculation of the exhaust gases during the idle state or extended idle conditions of the engine 102, mitigating fouling of the EGR cooler 148. Also, the life and reliability of the EGR cooler 148 may be improved based on the modulation of the set-point temperature of the coolant. Also, the system conducts the modulation in such a manner that the engine 102 of the locomotive may be ready to load anytime the user changes the throttle setting.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A control system for an exhaust gas recirculation system for an engine, the control system comprising:
an exhaust gas recirculation (EGR) cooler having a coolant flowing therethrough;
an externally controlled coolant set-point circuit associated with the EGR cooler; and
a controller communicably coupled to the externally controlled coolant set-point circuit, the controller configured to:
receive a first signal indicative of a readiness of the engine to load;
receive a second signal indicative of a temperature of the coolant;
receive a third signal indicative of a first temperature zone associated with the engine; and
modulate a set-point temperature of the coolant over a range of temperatures based on the received signals and a temperature gradient of the coolant.

2. The control system of claim 1, wherein the controller is further configured to control a fan speed of a cooling fan associated with the externally controlled coolant set-point circuit.

3. The control system of claim 1, wherein the controller is further configured to receive a fourth signal indicative of ambient temperature.

4. The control system of claim 1, wherein the modulation in the set-point temperature further includes lowering the set-point temperature during an idle state of the engine.

5. The control system of claim 4, wherein the controller is configured to lower the set-point temperature during the idle state of the engine such that the set-point temperature lies in a predefined cold zone of the engine.

6. The control system of claim 4, wherein the controller is configured to restrict recirculation of exhaust gases associated with the engine based on the modulation in the set-point temperature of the coolant during the idle state of the engine.

7. The control system of claim 1, wherein the range of temperatures lies between 50 and 65° C.

8. The control system of claim 1, wherein the first temperature zone of the engine is a predefined hot zone of the engine.

9. The control system of claim 1, wherein the controller is communicably coupled to at least one of an electronic control system associated with the engine and a control unit associated with a locomotive.

10. A method for controlling an exhaust gas recirculation system for an engine, the method comprising:
receiving, by a controller, a first signal indicative of a readiness of the engine to load;
receiving by the controller, a second signal indicative of a temperature of a coolant associated with an exhaust gas recirculation (EGR) cooler;
receiving, by the controller, a third signal indicative of a first temperature zone associated with the engine; and
modulating, by the controller, a set-point temperature of the coolant over a range of temperatures based on the received signals and a temperature gradient of the coolant.

11. The method of claim 10 further comprising controlling, by the controller, a fan speed of a cooling fan associated with an externally controlled coolant set-point circuit of the EGR cooler.

12. The method of claim 10 further comprising receiving, by the controller, a fourth signal indicative of ambient temperature.

13. The method of claim 10, wherein the modulation in the set-point temperature further includes lowering the set-point temperature during an idle state of the engine.

14. The method of claim 13, wherein the lowering of the set-point temperature during the idle state of the engine is such that the set-point temperature lies in a predefined cold zone of the engine.

15. The method of claim 13 further comprising restricting, by the controller, recirculation of exhaust gases associated with the engine based on the modulation in the set-point temperature of the coolant during the idle state of the engine.

16. The method of claim 10, wherein the range of temperatures lies between 50 and 65° C.

17. The method of claim 10, wherein the first temperature zone of the engine is a predefined hot zone of the engine.

18. An engine system for a locomotive, the engine system comprising:
an exhaust gas recirculation system;
an exhaust gas recirculation (EGR) cooler having a coolant flowing therethrough;
an externally controlled coolant set-point circuit associated with the EGR cooler, the externally controlled coolant set-point circuit including a radiator and a cooling fan associated therewith; and
a controller communicably coupled to the externally controlled coolant set-point circuit, the controller configured to:
receive a first signal indicative of a readiness of the engine to load;
receive a second signal indicative of a temperature of the coolant;
receive a third signal indicative of a first temperature zone associated with the engine;
modulate a set-point temperature of the coolant over a range of temperatures based on the received signals and a temperature gradient of the coolant; and
control a fan speed of the cooling fan based on the modulation.

19. The engine system of claim 18, wherein the controller is further configured to receive a fourth signal indicative of ambient temperature.

20. The engine system of claim 18, wherein the modulation in the set-point temperature further includes lowering the set-point temperature during an idle state of the engine.
